(19) United States
(12) Patent Application Publication
(10) Pub. No.: US 2008/0196055 A1
(43) Pub. Date: Aug. 14, 2008

(54) RESTRICTING ACCESS TO CONTENT

(75) Inventors: Frank Sandoval, Louisville, CO (US); Paul Hudson, Arlington, VA (US); Judson Cary, Denver, CO (US)

Correspondence Address: BROOKS KUSHMAN P.C., 1000 TOWN CENTER, TWENTY-SECOND FLOOR, SOUTHFIELD, MI, 48075, US

(73) Assignee: CABLE TELEVISION LABORATORIES, INC., Louisville, CO (US)

(21) Appl. No.: 11/673,012

(22) Filed: Feb. 9, 2007

(51) Int. Cl. H04N 7/16

(52) U.S. Cl. 725/25; 348/E07.085

(57) ABSTRACT

A method and system generally directed towards limiting access to content. The access may be limited as a function of permissible and impermissible content. An access point may be provided with permissible and impermissible content, such as from a media content provider, and controlled to limit access to the permissible content.

### BACKGROUND OF THE INVENTION

1. Field of the Invention

The present invention relates to restriction access to content, such as but not limited to restricting access to content accessed through an access point.

2. Background Art

Today's cable environment offers an enormous range of choice for programming; from hundreds of broadcast options, to thousands of on-demand options, and for many viewers, dozens of DVR recorded programs. Navigating or otherwise restricting content in such a large universe of programming is becoming increasingly difficult. One solution relates to a filtering based service that allows viewers to install a set of parental blocks or other filters such that programs matching the filter descriptions are blocked from viewing, thereby easing navigation to content more likely to be of interest. The problem with such filtering is that a vast amount of unwanted content still passes through to the viewer.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a system for restricting content in accordance with one non-limiting aspect of the present invention;

FIG. 2 illustrates a flowchart of a method for restricting content in accordance with one non-limiting aspect of the present invention;

FIG. 3 illustrates an electronic programming guide (EPG) in accordance with one non-limiting aspect of the present invention; and

FIG. 4 illustrates a third party content recommendation menu in accordance with one non-limiting aspect of the present invention.

### DETAILED DESCRIPTION OF THE PREFERRED EMBODIMENT(S)

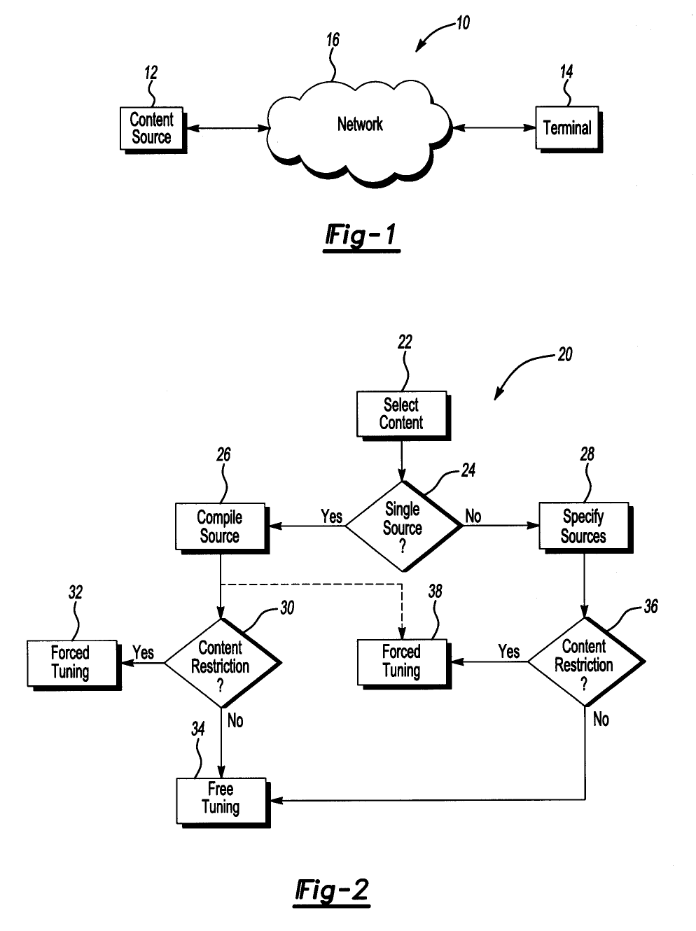

FIG. 1 illustrates a system 10 for restricting content in accordance with one non-limiting aspect of the present invention. The system 10 generally applies to any environment where content associated with a content source 12 may be delivered to a media access point 14 having features to facilitate interfacing the media with a user or other entity. The system 10 may be adapted to any number of environments and configured to carry or otherwise facilitate any type of electronically transmissible media having content. The media may be transmitted over a network 16 or other communication medium (portable memory, etc.) having capabilities sufficient to deliver the media from one location to another.

The content source 12 may be associated with any type of media provider having capabilities to transmit media and/or any number of affiliated or non-affiliated content sources having capabilities to transmit content to the access point 14. For exemplary purposes only and without intending to limit the scope and contemplation of the present invention, the content source 12 may be associated with a multiple system operator (MSO) or other entity associated with providing services to any number of subscribers by way of any number of media access points 14. Such MSO's may include but are not limited to cable, satellite, or broadcast television service providers, communication or cellular providers, internet service providers (data), and the like.

The network 16 may be associated with any type of network and include any combination of wireline and/or wireless features and devices to facilitate the electronic transmission of media. The network 16 may include multiple connections points and devices to facilitate media transmission, including but not limited to transmissions occurring through fixed media (CDs, DVDs, portable memory) and transmissions over electronic networks, such as but not limited to wireline and wireless networks. As such, the network 16 is intended to represent a method of transferring electronic media (portable memory) and/or an infrastructure for transferring electronic media (wireline/wireless network).

The access point 14 may be associated with any type of access point suitable for interfacing the media with the user and/or otherwise processing the media for subsequent use. The access point may include but is not limited to a settop box (STB), digital video recorder (DVR), personal computer (PC), television (which may include embedded user interface and processing capabilities), outlet digital adapter (ODA), media access point adapter (MTA), cable modem (CM), personal digital assistant (PDA), computer, mobile device (phone, computer, etc.), personal media device, audio/video player, and/or any other feature having capabilities for processing media. For exemplary purposes, a single access point 14 is illustrated. The present invention is not so limited and fully contemplates the system including and supporting any number of access points 14.

FIG. 2 illustrates a flowchart 20 of a method for restricting content in accordance with one non-limiting aspect of the present invention. The method generally relates to restricting content such that an access point is limited to accessing particular content. The method applies to the transmission of any type of media and limiting the content associated therewith, which for exemplary purposes, and without intending to limit the scope and contemplation of the present invention, is predominately described with respect to limiting access to content associated with television service provider.

Block 22 relates to selecting content that is accessible to the access point or otherwise permissible for access through the access point. This may include identifying a user of the access point, preferences, habits, and/or any number of other parameters associated with the access point. Menus, user interface, web portals/sites, and/or any number of other features may be provided to the access point and/or otherwise made accessible to a user or other entity in order to facilitate selecting the permissible content.

The permissible content may be specified according to any number of parameters. Permissible content may be specified/selected by title, description, genre, and content specific criteria; by viewing habits, recommendations, past viewing, and other non-user specified parameters; and/or by ratings (G, violence, language, etc.), peer reviews (four stars, etc.), channel, content source, and/or other non-content specific criteria. Each type of selection may be provided through a listing or other compilation of programs from a third party, a recommendations menu, a playlist, and/or any number of other sources, from which the content may be selected.

The content specific based selection process may be advantageous in allowing the user to personally and specifically select the program names, titles, movies, etc. that are permissible for access through the access point. This allows the user to select specific content at a granular level. The rating, channel, content source or more other more generic based selection processes may be advantageous in saving the user from having to specifically identify content, as the user may simply identifying all content falling within a certain classification to be permissible. The recommendation or third party based selection process may allow the user to defer to the judgment of another entity when selecting permissible content, such as a trusted authority, including but not limited to an association or group having with a common religious background or belief system as the user.

Optionally, other restrictions or limitations may be applied to the selected content. Temporal restraints may be added to limit content permissibility as a function of a time of day, days of the week, etc. This may be helpful with parental control and other situations where the user may limit programming availability to particular times of day. Password or other authorization restraints may be included such that the viewer or other party attempting to access the content may be required to input a password or other authorization before being granted access, such as to permit overriding parental controls and/or to further limit the selected content to include enhanced security. Optionally, the additional features may be automatically included during the selection process, such as but not limited to playlist based selections wherein the playlist specifies a particular order of content to be played in successive showings, which may further require playing the specified content at a particular time of day.

Block 24 relates to determining whether the selected content is to be transmitted according to unicast and/or multicast communications. This determination may be based on the content sources used to provide the associated media and/or the transmission of the media, i.e., individual channels associated with television broadcast may be considered as content sources even though the channel is not sourcing the content. Block 26 relates to unicast communications and Block 28 relates to multicast (broadcast) transmission. The unicast transmission may relate to compiling the selected content into a virtual channel or other dedicated channel such that the corresponding complied channel only carries the selected content. The multicast transmission may relate to broadcasting the content over their normally occurring channels whereby multiple access points are permitted access to the same channels and corresponding content.

Block 26 relates to determining a unicast transmission and compiling the content in an on demand manner (playlist) such that the content begins to play when the channel is accesses and/or on a revolving basis (permissions schedule) such that content automatically plays throughout the day, or when scheduled, on the compiled channel. The content associated with the compiled channel may be collected from any number of content sources and arranged or otherwise complied into the compiled channel, which may be common QAM channel, VOD channel, or other unicast transmission channel/stream. Of course, the present invention is not limited to carrying the content on television channels and fully contemplates compiling or otherwise preparing the content for transmission from any number of sources and according to any number of transmission procedures.

Block 30 relates to determining whether a content restriction process is activated on the access point. This may include determining whether a parental control feature has been activated and/or whether the user has demonstrated some other desire to limit the access point to showing the permissible content. Block 32 relates to the content restriction process being active and Block 34 relates to the content restriction process being inactive.

When the content restriction process is active, the access point may be limited to accessing only the permissible content. This may include forcing the access point to tune to the compiled channel having the permissible content such that the access point is unable to tune in or otherwise access other channels. Optionally, the content restriction may be limited to specified temporal restrictions, such as but not limited to forcing tuning to the compiled channel during specified periods of time, such as to instigate parental control during a period of time when a parent is away or otherwise unlikely to monitor the accessed content.

When the content restrictions process is inactive or expired, the access point may be free to access content normally available to the access points. The range of such access may be dictated according to a subscription or other requirements, but it generally relates to non-specified content being accessible through the access point, which would not otherwise be accessible if the restriction process was active. Optionally, even when the restriction process is inactive, passwords or other authorization may be required to access the non-specified content and/or menus or other features may highlight or emphasis the selected content, such as but not limited to highlighting in EPGs and other menus, so as to draw attention to content likely to be of interested to the user.

Returning to Block 24, Block 28 relates to determining a multicast transmission and specifying the channels or other sources associated with the multicast transmission. Block 28 may relate to specifying the channel and times associated with the selected programs, identifying channels generally designated as having permissible content, and/or otherwise matching the permissible content with the channels/sources associated therewith and according to the parameters or other limitations specified with the selection thereof. For example, a time of day based channel schedule may be developed for listing the channels and corresponding time of day associated with the permissible content.

Block 36 relates to determining whether a content restriction process is activated on the access point. This may include determining whether a parental control feature has been activated and/or whether the user has demonstrated some other desired to limit the access point to showing the permissible content. Block 38 relates to the content restriction process being active and Block 34 relates to the content restriction process being inactive.

When the content restriction process is active, the access point may be limited to accessing only the permissible content. This may include prohibiting the access point from tuning to channels having non-permissible content, limiting channel tuning to the channels specified in the channel schedule for the current time of day, and/or otherwise limiting access thereto, such as but not limited to descrambling the corresponding signals and/or requiring a password or other user restricted user input. Optionally, as shown with the dashed line, the restricted tuning may include permitting access to the compiled channel in addition to the other channels, which may be advantageous if a portion of the permissible content is carried in the complied channel.

In this manner, one non-limiting aspect of the method of the present invention may relate to specifically identifying content permissible for access through the access point and limiting the access point to accessing the corresponding content. This may be useful in positively identifying content suitable for viewing through the access point. Optionally, the content may be specified at a granular level such that individual pieces of content must be selected in order to be permissible, as opposed to more generic section process based on channel numbers, parental ratings, and other one-size fits all solutions.

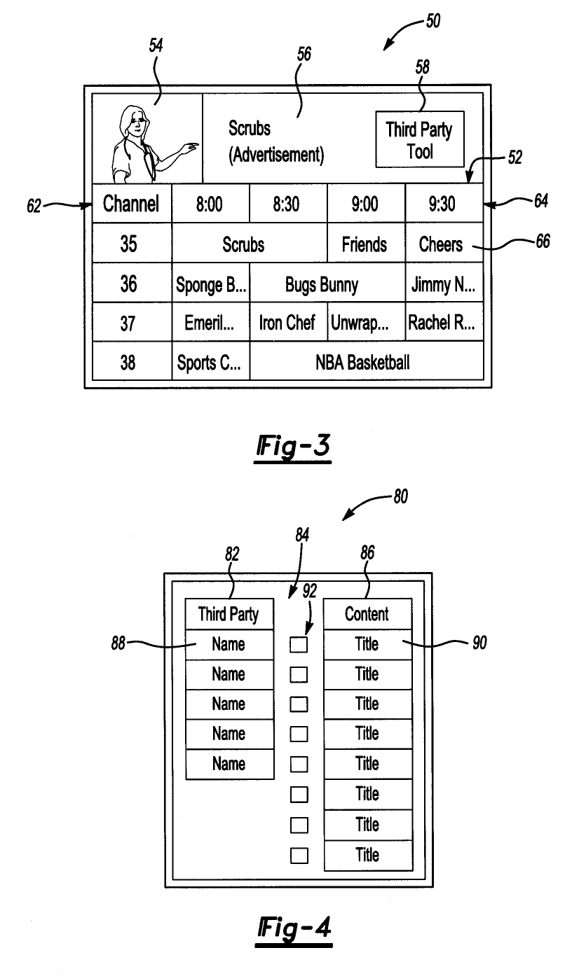

FIG. 3 illustrates an electronic programming guide (EPG) 50 in accordance with one non-limiting aspect of the present invention. The EPG 50 may be configured to facilitate selection of the permissible content. The EPG 50 is shown for exemplary purposes only and without intending to limit the scope and contemplation of the present invention. The EPG 50 generally relates to any user interface associated with the access point and may include any number of features, and not just those described below. EPGs are commonly employed with settop boxes (STBs) and similar devices.

The EPG 50 may include a number of menus, buttons, features, navigation items, and other elements associated with displaying or otherwise navigating a user to content associated with the content source (MSO or other entity). The EPG 50 may include a channel map 52, an image portion 54, description menu 56, and/or a content selection tool 58. The channel map 52 may display various programs showing during a particular time of day. The image portion 54 may show images associated with a tuned to channel, advertisements, and other features. The description menu 56 may show a textual description, advertisement, or the feature associated with a highlighted cell of the channel map. The content selection tool 58 may navigate to another menu associated with third party content recommendations (see FIG. 4)

The channel map 52 may include schedule of channels and corresponding program titles showing during a particular time of day, as indicated with a channel column 62, time of day row 64, and program titles 66. The permissible programs may be selected directly from the EPG by highlighting or otherwise identifying the program titles 66. Shown programs or programs showing in the future may be similarly selected through scrolling the display rearwardly and forwardly in time. The selected programs may be designated as being permissible delivered to the access point as described above (shown programs may be limited to the unicast transmission process).

Optionally, the content selection tool 58 may be selected to view content recommended by a third party. FIG. 4 illustrates a third party content recommendation menu 80 in accordance with one non-limiting aspect of the present invention. The menu 80 is shown for exemplary purposes and without intending to limit the scope and contemplation of the present invention. The menu 80 may include any number of features associated with recommending content and is not intended to be limited to the features described herein.

The menu 80 may include a third party column 82, a selection box column 84, and a content title column 86. The third party column 82 may indicate names 88 of third parties selected by a user of the EPG and/or otherwise associated therewith. Each of the names 88 may be highlighted to display a corresponding listing of titles 90 within the content title column 86. The user may review the content titles 90 and select the corresponding selection box 92 in order to designate the content as being permissible. The content title may indicate a class of content and/or individual pieces of content, such as but not limited to television series (class) or single showing within the television series (individual piece). The content titles may be selected to display additional information for the corresponding title, such as but not limited to a description, rating, genre, etc.

The third parties may be friends, groups, and/or any number of other entities. The third parties may be associated with human driven entities that have reviewed or otherwise personally assessed the subject matter and material associated with the content and determined the permissibility of the same. The third parties may be differentiated from machine driven selection features and filters that review content according to keywords, rating (i.e. those associated with the source producing the work as opposed to a rating based on personal review), and other selectable parameters without regard to the nature and presentation of the material. This may be helpful in preventing children from viewing suggestive cartoons, advertisements, etc., that may not include offensive language or ratings (i.e. content that may pass through the machine filters) but do include otherwise acceptable material presented in an unacceptable fashion.

The ability to import third party recommendations may be helpful to parents and other individuals in expediting the decision making process associated with selecting permissible content. For example, one or more of the third parties may be associated with a children's group or other entity associated with screening content. The entity may screen the content and make viewing recommendations to the user by way of the content selection tool. The user may automatically select all the recommended content as being permissible and/or individually assess and select the permissibility of each piece of content. In this manner, the parent may be provided with a screened list of content without having to personally generate the content list. Similar listing may be used for topics of interests and other matters for which the user may desire complied listed of information from a similarly trusted authority. The listed content may then be delivered to the access point as described above.

One non-limiting aspect of the present invention relates to a means by which programming channels, programming events and series, and advertising may be identified in such a way as to allow such content to either be blocked, as for parental control, be recommended for viewing or recording, or for other convenience or useful purposes.

One non-limiting aspect of the present invention allows for programming content to be associated with attributes. The identification of content and its associated attributes may be embodied in computer files. Such files may be generated in a number of ways, and distributed to devices that receive television programming. Television receivers may make use of such data in a variety of ways; the data may be presented to viewers, who make viewing choices based on it, or the data may be used by the software of the receiver to augment the navigation features it provides. An example of the latter is to import a description of programs unsuitable for children, and automatically block such programming.

There are many uses of the present invention. Some ideas include: viewing and recording recommendations from friends, media mavens, or celebrities. These recommendations might be used like iPod playlists or to promote branded content and celebrities—like the purchase of Snoop Dogg's favorite shows, which could be used by a DVR system to automatically store the indicated programs. The ability of the present invention to selective present information at a granular level is advantageous in controlling content accessed through the access point. The presentation may include but is not limited to controlling content actually viewed through the access point and/or whether the content is shown in menus and other tools associated with locating content.

A standardized content format having entries for programming channels, events and series, and advertising content may be used. Each entry may be associated with a number of properties. Properties may express attributes of the entry such as parental rating and recommendation value. The format may be extensible to allow for the identification of new content types and the definition of new properties.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of restricting content accessed through a media access point, the method comprising:
selecting content permissible for access through the access point; and
limiting the access point to the permissible content such that the access point is disabled from presenting non-permissible content.

2. The method of claim 1 further comprising directing the access point to acquire permissible content such that the access point is only able to present the permissible content.

3. The method of claim 2 further comprising directing the access point to the channel if a content control feature is enabled.

4. The method of claim 1 further comprising associating the permissible content within one or more channels included in a time of day based channel schedule and limiting presentation by the access point to the channels specified in the channel schedule such that the access point is limited to presentation of the channels schedule for the current time of day.

5. The method of claim 1 further comprising compiling the permissible content into a compiled channel such that the permissible content is accessed through tuning the access point to the compiled channel.

6. The method of claim 5 further comprising directing the access point to tune to the complied channel if a content control feature is enabled.

7. The method of claim 5 further comprising configuring the compiled channel to be an on demand channel such that the permissible content is transmitted on demand when the access point tunes to the compiled channel.

8. The method of claim 1 further comprising selecting the permissible content through an electronic programming guide (EPG).

9. The method of claim 8 further comprising including a feature in the EPG to facilitate selecting the permissible content according to a recommendation of permissible content provided by a third party.

10. The method of claim 1 further comprising selecting the permissible content through direct identification of a content title.

11. The method of claim 10 further comprising selecting the permissible content without selecting a classification associated with the content such that each piece of content is specifically and not generically selected.

12. The method of claim 1 further comprising limiting content transmissions to the access point to the permissible content such that non-permissible content is not transmitted to the access point.

13. The method of claim 1 wherein selecting the permissible content requires individually selecting pieces of content at a granular level.

14. A method of limiting playback of media content available form a media content provider, the method comprising:
associating a playlist with a media access point used to playback the media content; and
if a restricted access program of the media access point is engaged, limiting the media access point to playback of the media content specified in the playlist.

15. The method of claim 13 wherein limiting the media access control point includes limiting media available for playback or recording from a digital video recorder (DVR) associated with the media access point.

16. The method of claim 13 wherein limiting the media access point includes limiting channels presented to by the media access point.

17. The method of claim 13 further comprising limiting the available playlists to playlists associated with trusted content providers previously authorized by a user associated with the media access point.

18. A system for restricting access to content associated with a media content provider, the system comprising:
an access point configured for accessing the content;
an electronic programming guide (EPG) having menus associated with selecting content permissible for access through the access point; and
wherein the access point is configured to limit access to the permissible content if a content control feature is enabled.

19. The system of claim 17 wherein the EPG includes a menu for identifying a third party and selecting permissible content as a function of recommendations associated with the third party.

20. The system of claim 18 wherein the EPG provides a title listing of available content such that each title is individually selectable for specifying the permissible content.
